(19) United States
(12) Patent Application Publication
(10) Pub. No.: US 2025/0317659 A1
(43) Pub. Date: Oct. 9, 2025

(54) RADIATION IMAGING APPARATUS, CONTROL METHOD THEREFOR, AND STORAGE MEDIUM

(71) Applicant: CANON KABUSHIKI KAISHA, Tokyo (JP)

(72) Inventor: HIROKI ASAI, Kanagawa (JP)

(21) Appl. No.: 19/170,835

(22) Filed: Apr. 4, 2025

(30) Foreign Application Priority Data
Apr. 8, 2024 (JP) 2024-062288
Jan. 27, 2025 (JP) 2025-011405

(51) Int. Cl. H04N 25/30; H04N 23/30; H04N 23/73

(52) U.S. Cl. CPC H04N 25/30; H04N 23/30; H04N 23/73

(57) ABSTRACT

An apparatus includes a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, wherein an output impedance of the bias supply circuit differs depending on whether an imaging mode for radiographic imaging is radiographic imaging which performs automatic exposure control that is based on the dose of the radiation detected by the detection pixel.

### BACKGROUND

### Technical Field

Aspects of the embodiments generally relate to a radiation imaging apparatus, a control method therefor, and a storage medium.

### Description of the Related Art

Radiation imaging apparatuses each using a sensor panel provided with a plurality of pixels for detecting radiation such as X-rays are widely used in the fields of, for example, industry and healthcare. Recently, the diversification of functions of radiation imaging apparatuses has been being considered, and one of the considered functions is, for example, a function which monitors (observes or detects) irradiation of radiation. This function enables, for example, detection of timing at which irradiation of radiation by a radiation generation device has been started, detection of timing at which irradiation of radiation has been stopped, and detection of the irradiation dose of radiation or the accumulated irradiation dose of radiation.

Japanese Patent Application Laid-Open No. 2016-25465 discusses a radiation imaging apparatus which performs automatic exposure control (AEC) for controlling irradiation of radiation by a radiation generation device according to the dose of radiation for irradiation to each pixel by the radiation generation device. Japanese Patent Application Laid-Open No. 2010-268171 discusses a radiation imaging apparatus which performs automatic detection control for detecting an amount by which a current flowing through a bias supply circuit, which supplies a voltage to a pixel array, is changed by irradiation of radiation and thus detecting irradiation of radiation by the radiation imaging apparatus itself to perform radiographic imaging.

However, in the technique discussed in Japanese Patent Application Laid-Open No. 2016-25465, there is an issue in which, at the time of, after automatic exposure control, reading out an electrical signal for generating a radiographic image from each pixel, artifacts may occur in a radiographic image due to a change of variation of a bias voltage to be supplied to each pixel. Moreover, if control to prevent or reduce the variation of a bias voltage is performed, the detection sensitivity in automatic detection control for irradiation of radiation such as that discussed in Japanese Patent Application Laid-Open No. 2010-268171 decreases, so that the detection accuracy may decrease in such a manner that, for example, a false detection in irradiation of radiation occurs.

### SUMMARY

According to an aspect of the embodiments, an apparatus includes a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, wherein an output impedance of the bias supply circuit differs depending on whether an imaging mode for radiographic imaging is radiographic imaging which performs automatic exposure control that is based on the dose of the radiation detected by the detection pixel.

Further features of the disclosure will become apparent from the following description of exemplary embodiments with reference to the attached drawings.

### BRIEF DESCRIPTION OF THE DRAWINGS

FIG. 1 is a diagram illustrating an example of an outline configuration of a radiation imaging system according to a first exemplary embodiment.

FIG. 2 is a diagram illustrating an example of an outline configuration of a radiation imaging apparatus according to the first exemplary embodiment.

FIG. 3 is a diagram illustrating an example of a timing chart in a control method for the radiation imaging apparatus according to the first exemplary embodiment.

FIG. 4 is a diagram illustrating a first example of an internal configuration of a bias supply circuit illustrated in FIG. 2 in the radiation imaging apparatus according to the first exemplary embodiment.

FIG. 5 is a diagram illustrating a second example of an internal configuration of the bias supply circuit illustrated in FIG. 2 in the radiation imaging apparatus according to the first exemplary embodiment.

FIG. 6 is a diagram illustrating an example of a flowchart in a control method for a radiation imaging system according to a second exemplary embodiment.

### DESCRIPTION OF THE EMBODIMENTS

Various exemplary embodiments, features, and aspects of the disclosure will be described in detail below with reference to the drawings. However, constituent elements described in the following exemplary embodiments are merely illustrated as examples, and the technical scope of the disclosure should be defined by the appended claims and should not be construed to be limited to the following description of exemplary embodiments.

First, a first exemplary embodiment is described.

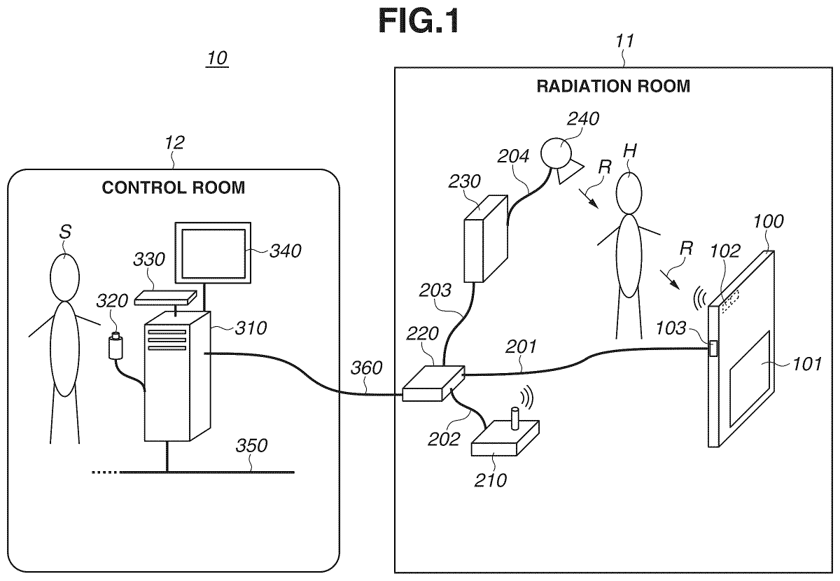

FIG. 1 is a diagram illustrating an example of an outline configuration of a radiation imaging system 10 according to the first exemplary embodiment. As illustrated in FIG. 1, the radiation imaging system 10 is configured to be divided into a radiation room 11, in which to perform radiographic imaging which performs irradiation of radiation R, and a control room 12, which is installed near the radiation room 11.

The radiation room 11 includes, as constituent elements of the radiation imaging system 10, a radiation imaging apparatus 100, an access point (AP) 210, a communication control device 220, a radiation generation device 230, and a radiation source 240. The radiation room 11 further includes, as constituent elements of the radiation imaging system 10, a radiation imaging apparatus communication cable 201, an AP communication cable 202, a radiation generation device communication cable 203, and a radiation source communication cable 204.

The control room 12 includes, as constituent elements of the radiation imaging system 10, a control device 310, a radiation irradiation switch 320, an input device 330, a display device 340, an in-hospital local area network (LAN) 350, and a radiation room communication cable 360.

The radiation imaging apparatus 100 is an apparatus which performs imaging which uses radiation R and is an apparatus configured in such a way as to be able to communicate with the communication control device 220 and the control device 310. In the first exemplary embodiment, the radiation imaging apparatus 100 can be configured as an apparatus capable of performing two types of radiographic imaging, i.e., radiographic imaging which performs automatic exposure control (AEC) and radiographic imaging which does not perform automatic exposure control (AEC). In this instance, examples of the radiographic imaging which does not perform automatic exposure control (AEC) include radiographic imaging which performs automatic detection control which is different from the automatic exposure control (AEC) and which automatically detects irradiation of radiation R in the radiation imaging apparatus 100. Moreover, the radiation imaging apparatus 100 detects incident radiation R (including radiation R transmitted through a subject H present in the radiation room 11) and thus generates radiographic image data. The radiation imaging apparatus 100 includes, as illustrated in FIG. 1, a power source control unit 101, which is composed of, for example, a battery, a wireless communication unit 102, and a wired communication unit 103. The wireless communication unit 102 is a communication unit which takes charge of wireless communication to be performed between the wireless communication unit 102 and each of the communication control device 220 and the control device 310 via the access point (AP) 210 and the AP communication cable 202. The wired communication unit 103 is a communication unit which takes charge of wired communication to be performed between the wired communication unit 103 and each of the communication control device 220 and the control device 310 via the radiation imaging apparatus communication cable 201.

The radiation imaging apparatus communication cable 201 is a cable which is used to interconnect the radiation imaging apparatus 100 and the communication control device 220 in such a manner that the radiation imaging apparatus 100 and the communication control device 220 are able to communicate with each other. The AP communication cable 202 is a cable which is used to interconnect the access point (AP) 210 and the communication control device 220 in such a manner that the access point (AP) 210 and the communication control device 220 are able to communicate with each other.

The access point (AP) 210 performs wireless communication with the radiation imaging apparatus 100 (specifically, the wireless communication unit 102 of the radiation imaging apparatus 100). The communication control device 220 takes charge of communications with various devices included in the radiation imaging system 10. In the radiation imaging system 10, for example, various setting commands for use in radiographic imaging and radiographic image data obtained by radiographic imaging are communicated between the radiation imaging apparatus 100 and the control device 310 via the communication control device 220. Moreover, in the radiation imaging system 10, for example, synchronization signals for use in radiographic imaging are communicated between the radiation imaging apparatus 100 and the radiation generation device 230 via the communication control device 220. In this instance, the synchronization signals include, for example, an irradiation enabling signal for radiation R and an irradiation stop signal for radiation R.

The radiation generation device 230 controls the radiation source 240 in such a way as to irradiate radiation R that is based on a predetermined radiation irradiation condition and thus causes the radiation source 240 to irradiate the radiation R toward the subject H and the radiation imaging apparatus 100. The radiation generation device communication cable 203 is a cable which is used to interconnect the radiation generation device 230 and the communication control device 220 in such a manner that the radiation generation device 230 and the communication control device 220 are able to communicate with each other. The radiation source communication cable 204 is a cable which is used to interconnect the radiation source 240 and the radiation generation device 230 in such a manner that the radiation source 240 and the radiation generation device 230 are able to communicate with each other. The radiation source 240 irradiates radiation R toward the subject H and the radiation imaging apparatus 100 under the control of the radiation generation device 230.

The control device 310 communicates with the radiation imaging apparatus 100 and the radiation generation device 230 via the radiation room communication cable 360 and the communication control device 220 and thus comprehensively controls operations of the radiation imaging system 10. For example, the control device 310 also performs control of the radiation imaging apparatus 100, which performs imaging which uses radiation R.

The radiation irradiation switch 320 is a switch which is used to input irradiation timing of radiation R by an operation performed by an operator S.

The input device 330 is a device which receives an operation input from the operator S, and includes various input devices such as a keyboard and a touch panel. Information received as an operation input by the input device 330 is input to the control device 310.

The display device 340 is a device which displays various pieces of information and various images under the control of the control device 310. The display device 340 is a device which performs, for example, displaying of a radiographic image subjected to image processing or displaying of a graphical user interface (GUI) screen, and includes, for example, a display.

The in-hospital LAN 350 is a backbone network in a hospital.

The radiation room communication cable 360 is a cable which is used to interconnect the control device 310 and the communication control device 220 included in the radiation room 11.

Next, operations of the radiation imaging system 10 are described.

First, the operator S inputs and sets, to the control device 310 via the input device 330, subject information such as an identifier (ID), name, and birth date of the subject H and imaging information such as an imaging region of the subject H. The imaging information can include information (command) indicating ON/OFF of the function of automatic exposure control (AEC) in the radiation imaging apparatus 100. Moreover, the imaging information can include, as parameters, information indicating a selected region in a region of interest (RIO) of a pixel array of the radiation imaging apparatus 100 which is used in automatic exposure control (AEC) and information about a threshold value concerning the dose of radiation R. Additionally, the imaging information can include, as parameters, information indicating an arithmetic operation method employed in using a plurality of regions of interest (RIOs), information indicating a sensitivity correction value, information indicating a density correction value, and information indicating a sensor rotational angle. Furthermore, the subject information or the imaging information not only can be set by the operation S performing direct inputting to the input device 330 but also can be automatically set by the operator selecting an examination order received via the in-hospital LAN 350. Moreover, information about the imaging region of the subject H included in the imaging information can also be set by the operator S selecting a previously set imaging protocol.

After setting the subject information and the imaging information, the operator S fixes the attitude of the subject H and the position of the radiation imaging apparatus 100. After the completion of imaging preparations for the subject H and the radiation imaging apparatus 100, the operator S presses the radiation irradiation switch 320. In response to the radiation irradiation switch 320 being pressed, radiation R is irradiated from the radiation source 240 toward the subject H and the radiation imaging apparatus 100.

The radiation R irradiated to the subject H passes through the subject H and falls on the radiation imaging apparatus 100. For example, the radiation imaging apparatus 100 converts incident radiation R into visible light by phosphors, then converts the visible light into an electrical signal for a radiographic image (radiographic image signal) by photoelectric conversion elements, and performs analog-to-digital conversion of the electrical signal, thus generating digital radiographic image data. The digital radiographic image data generated by the radiation imaging apparatus 100 is transmitted from the radiation imaging apparatus 100 to the control device 310. The control device 310 performs image processing on the received digital radiographic image data, and displays, on the display device 340, a radiographic image that is based on the radiographic image data subjected to image processing. In this instance, the control device 310 functions as an image processing device and a display control device.

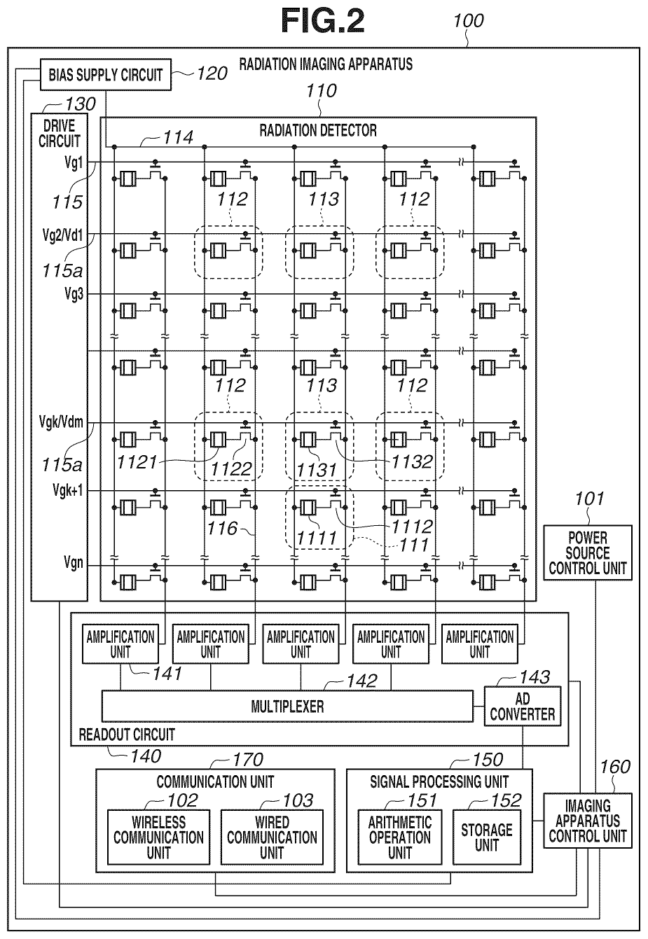

FIG. 2 is a diagram illustrating an example of an outline configuration of the radiation imaging apparatus 100 according to the first exemplary embodiment. In FIG. 2, constituent elements similar to the constituent elements illustrated in FIG. 1 are assigned the respective same reference characters as those illustrated in FIG. 1, and the detailed description thereof is omitted here.

As illustrated in FIG. 2, the radiation imaging apparatus 100 includes the power source control unit 101, a radiation detector 110, a bias supply circuit 120, a drive circuit 130, a readout circuit 140, a signal processing unit 150, an imaging apparatus control unit 160, and a communication unit 170.

The radiation detector 110 has the function of detecting incident radiation R, and includes a pixel array including a plurality of pixels 111 to 113 which acquires an electrical signal corresponding to the incident radiation R. Specifically, the radiation detector 110 includes a plurality of pixels 111 to 113 arrayed in such a way as to configure a plurality of rows and a plurality of columns, a plurality of bias lines 114, a plurality of drive lines 115, and a plurality of signal lines 116.

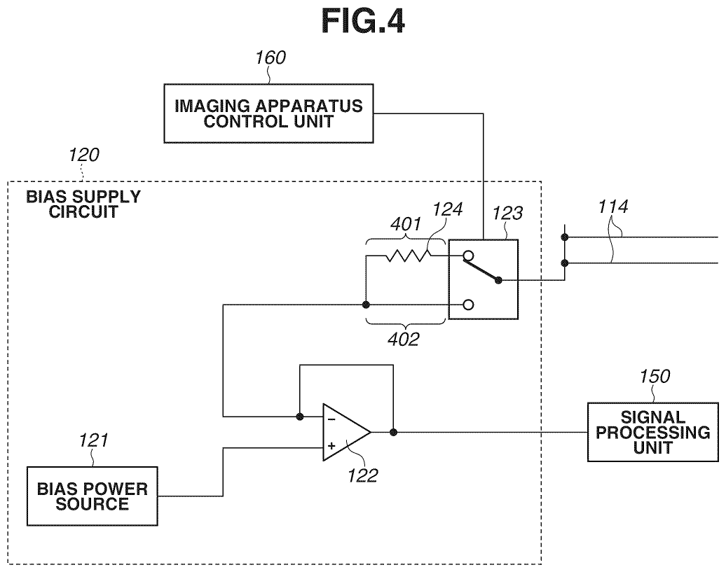

The plurality of bias lines 114 is a mass of electric wires which lie between a bias power source (a bias power source 121 illustrated in FIG. 4 described below) included in the bias supply circuit 120 and the plurality of pixels 111 to 113 and which are used to supply a bias voltage Vs from the bias power source to the plurality of pixels 111 to 113.

The plurality of drive lines 115 is arranged in conformity with a plurality of rows in the pixel array of the radiation detector 110, and each drive line 115 corresponds to any one of the pixel rows. Specifically, each drive line 115 has one end thereof connected to the drive circuit 130 and a portion thereof opposite to the one end connected to one pixel row.

The plurality of signal lines 116 is arranged in conformity with a plurality of columns in the pixel array of the radiation detector 110, and each signal line 116 corresponds to any one of the pixel columns. Specifically, each signal line 116 has one end thereof connected to the readout circuit 140 (an amplification unit 141) and a portion thereof opposite to the one end connected to one pixel column.

The plurality of pixels in the pixel array of the radiation detector 110 includes imaging pixels 111, detection pixels 112, and correction pixels 113.

Each of the imaging pixels 111 is a pixel used to capture (acquire) a radiographic image of the subject H. In the first exemplary embodiment, the pixels excluding the detection pixels 112 and the correction pixels 113 illustrated in FIG. 2 are the imaging pixels 111. Each of the imaging pixels 111 includes a conversion element 1111, which converts radiation R into an electrical signal to detect the incident radiation R as an electrical signal for a radiographic image, and a switching element 1112, which causes the signal line 116 and the conversion element 1111 corresponding thereto to connect to each other.

The detection pixels 112 are one or more pixels each of which is used to detect (monitor) the irradiation dose of radiation R as an electrical signal. The detection pixels 112 are arranged in such a way as to be included in rows and columns of a pixel array configured with the plurality of imaging pixels 111. Each of the detection pixels 112 includes a conversion element 1121, which converts radiation R into an electrical signal to detect the irradiation dose of radiation R as an electrical signal, and a switching element 1122, which causes the signal line 116 and the conversion element 1121 corresponding thereto to connect to each other.

The correction pixels 113 are one or more pixels each of which is used to correct the irradiation dose of radiation R. The correction pixels 113 are arranged in such a way as to be included in rows and columns of a pixel array configured with the plurality of imaging pixels 111. The sensitivity of the correction pixel 113 for radiation R is lower than the sensitivity of the detection pixel 112 for radiation R. Each of the correction pixels 113 includes a conversion element 1131, which converts radiation R into an electrical signal to detect an electrical signal for correcting the irradiation dose of radiation R, and a switching element 1132, which causes the signal line 116 and the conversion element 1131 corresponding thereto to connect to each other.

Each of the conversion element 1111, the conversion element 1121, and the conversion element 1131 illustrated in FIG. 2 can be formed with, for example, a first configuration including a scintillator which converts incident radiation R into light and a photoelectric conversion element which converts light generated by the scintillator into an electrical signal. In this instance, the scintillator is usually formed in a sheet-like shape in such a way as to cover the radiation detector 110, and is shared by a plurality of pixels 111 to 113. Each of the conversion element 1111, the conversion element 1121, and the conversion element 1131 can also be formed with, instead of the first configuration, a second configuration which applies a conversion element which directly converts incident radiation R into an electrical signal.

Each of the switching element 1112, the switching element 1122, and the switching element 1132 illustrated in FIG. 2 can be formed in such a way as to include, for example, a thin-film transistor (TFT) having an active region made from a semiconductor such as amorphous silicon or polycrystalline silicon.

In the following description, the conversion element 1111 and the switching element 1112, which are included in the imaging pixel 111 illustrated in FIG. 2, are described.

A first electrode of the conversion element 1111 illustrated in FIG. 2 is connected to a first main electrode of the switching element 1112, and a second electrode of the conversion element 1111 is connected to the bias line 114. One bias line 114 extends in the column direction of the pixel array and is connected equally to the second electrodes of a plurality of conversion elements 1111 arrayed in the column direction. The bias line 114 receives a bias voltage Vs from the bias supply circuit 120. Second main electrodes of the switching elements 1112 in one or more imaging pixels 111 included in one column of the pixel array are connected to one signal line 116. Moreover, control electrodes of the switching elements 1112 in one or more imaging pixels 111 included in one row of the pixel array are connected to one drive line 115.

Each of the detection pixel 112 and the correction pixel 113 illustrated in FIG. 2 also has a pixel configuration similar to above-mentioned pixel configuration of the imaging pixel 111 and is connected to the corresponding drive line 115 and the corresponding signal line 116. In the first exemplary embodiment, the detection pixel 112 and the correction pixel 113 are exclusively connected to the signal line 116. Thus, the correction pixel 113 is not connected to a signal line 116 to which the detection pixel 112 is connected. Moreover, the detection pixel 112 is not connected to a signal line 116 to which the correction pixel 113 is connected. Furthermore, the imaging pixel 111 can be connected to the same signal line 116 as that the signal line 116 to which the detection pixel 112 or the correction pixel 113 is connected.

The bias supply circuit 120 is a circuit which supplies a bias voltage Vs to the bias line 114 based on a control signal output from the imaging apparatus control unit 160.

The drive circuit 130 is configured to supply drive signals to respective pixels target for driving through a plurality of drive lines 115 based on a control signal output from the imaging apparatus control unit 160. In the first exemplary embodiment, the drive signal is a signal for turning on a switching element included in a pixel targeted for driving. The switching element included in each pixel is turned on in response to the input signal being at high level, and is turned off in response to the input signal being at low level. Therefore, the input signal being at high level is referred to as a “drive signal”. In response to the drive signal being supplied to a pixel, an electrical signal accumulated in a conversion element included in the pixel becomes able to be read out by the readout circuit 140. Moreover, in a case where a drive line 115 is connected to at least one of the detection pixel 112 and the correction pixel 113, the drive line 115 is referred to as a “detection drive line 115a”. In FIG. 2, drive lines 115 denoted by Vg2/Vd1 to Vgk/Vdm serve as detection drive lines 115a.

The readout circuit 140 is configured to read out electrical signals from a plurality of pixels 111 to 113 through a plurality of signal lines 116. Specifically, the readout circuit 140 includes a plurality of amplification units 141, a multiplexer 142, and an analog-to-digital converter (hereinafter referred to as an “AD converter”) 143. Each signal line 116 of the plurality of signal lines 116 is connected to the corresponding amplification unit 141 of the plurality of amplification units 141 included in the readout circuit 140. One signal line 116 corresponds to one amplification unit 141. The amplification unit 141 amplifies an electrical signal read out through the signal line 116. The multiplexer 142 selects each of the plurality of amplification units 141 in a predetermined sequential order, and supplies an electrical signal output from the selected amplification unit 141 to the AD converter 143. The AD converter 143 converts an analog electrical signal supplied from the multiplexer 142 into a digital electrical signal and then outputs the digital electrical signal.

Electrical signals read out from the imaging pixels 111 by the readout circuit 140 are supplied to the signal processing unit 150 and are then subjected to processing such as arithmetic operation and storing by the signal processing unit 150. Specifically, the signal processing unit 150 includes an arithmetic operation unit 151 and a storage unit 152. The arithmetic operation unit 151 generates a radiographic image based on the electrical signals read out from the imaging pixels 111, and then supplies the radiographic image to the imaging apparatus control unit 160. Moreover, electrical signals read out from the detection pixels 112 and the correction pixels 113 by the readout circuit 140 are supplied to the signal processing unit 150 and are then subjected to arithmetic operation by the arithmetic operation unit 151 and subjected to storing by the storage unit 152. Specifically, the signal processing unit 150 outputs information indicating the irradiation dose of radiation R for the radiation imaging apparatus 100 based on the electrical signals read out from the detection pixels 112 and the correction pixels 113. For example, the signal processing unit 150 calculates the irradiation dose of radiation R and/or the accumulated irradiation dose of radiation R for the radiation imaging apparatus 100.

The imaging apparatus control unit 160 not only comprehensively controls operations of the radiation imaging apparatus 100 and but also performs various processing operations. For example, the imaging apparatus control unit 160 controls the power source control unit 101, the bias supply circuit 120, the drive circuit 130, the readout circuit 140, the signal processing unit 150, and the communication unit 170 based on, for example, information received from the signal processing unit 150 and commands and parameters received from the control device 310. Here, the commands can include, for example, a command indicating ON/OFF of the function of automatic exposure control (AEC) and a command indicating an imaging mode for radiographic imaging. In this instance, the command indicating OFF of the function of AEC is a command indicating ON of the function of automatic detection control, which is a function different from the function of AEC and automatically detects irradiation of radiation R to the pixel array of the radiation detector 110 in the radiation imaging apparatus 100. Moreover, the parameters can include at least one of a selected region in a region of interest of a pixel array for use in the function of AEC, a threshold value for the dose of radiation R, an arithmetic operation method in using a plurality of regions of interest, a sensitivity correction value, a density correction value, and a sensor rotational angle. Additionally, the parameters can include at least one of a detection sensitivity and a detection threshold value of the above-mentioned function of automatic detection control. Moreover, the imaging apparatus control unit 160 controls, for example, starting and ending of exposure (accumulation of electric charge corresponding to incident radiation R by the imaging pixels 111) based on information received from the signal processing unit 150. The imaging apparatus control unit 160 can be configured with a general-purpose processing circuit such as a microprocessor or can be configured with a dedicated processing circuit such as an application specific integrated circuit (ASIC). Moreover, in a case where the imaging apparatus control unit 160 is configured with a general-purpose processing circuit, the imaging apparatus control unit 160 can further include a memory.

The communication unit 170 is controlled by the imaging apparatus control unit 160 and has the function of communicating with external devices outside the radiation imaging apparatus 100 (for example, the communication control device 220 and the control device 310). The communication unit 170 includes the wireless communication unit 102 and the wired communication unit 103 illustrated in FIG. 1. The wireless communication unit 102 takes charge of wireless communication with the communication control device 220 and the control device 310 via the access point (AP) 210 and the AP communication cable 202. The wired communication unit 103 takes charge of wired communication with the communication control device 220 and the control device 310 via the radiation imaging apparatus communication cable 201. In one embodiment, wireless communication by the wireless communication unit 102 or wired communication by the wired communication unit 103 only needs to be able to establish communication in a desired method or standard, and is not limited to a specific method or standard. Moreover, for the purpose of being compatible with a plurality of communication standards, a plurality of communication units 170 can be mounted in the radiation imaging apparatus 100.

Next, an issue occurring in a case where the radiation imaging apparatus 100 performs radiographic imaging with use of an automatic exposure control function (AEC function) is described.

The bias lines 114, which are used to supply a bias voltage Vs from the bias supply circuit 120, are connected to the respective pixels of the pixel array. Therefore, the bias voltage Vs is affected by the influence of electrical signals (such as image signals) being read out from the respective pixels, and the degree of such an influence becomes larger according to the amount of electric charge of the read-out electrical signals. At the time of AEC driving, in one embodiment, the drive circuit 130 applies the drive signal only to the detection drive line 115a to scan only the detection drive line 115a and brings only electrical signals from the detection pixel 112 and the correction pixel 113 into a state of being able to be read out. Next, the imaging apparatus control unit 160 controls the readout circuit 140 to read out electrical signals in columns corresponding to the detection pixel 112 and the correction pixel 113, and outputs the read-out electrical signals as information indicating the irradiation dose of radiation R. With such an operation, the radiation imaging apparatus 100 is able to acquire, during irradiation of radiation R in progress, information indicating the irradiation dose of radiation R obtained by the detection pixels 112. After such AEC driving, to generate a radiographic image for diagnosis, the drive circuit 130 sequentially supplies the drive signals to the drive lines 115.

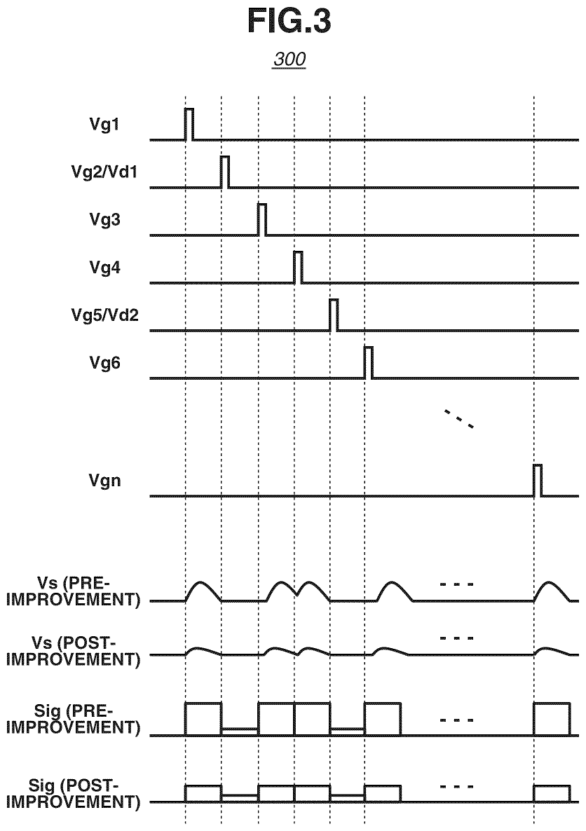

FIG. 3 is a diagram illustrating an example of a timing chart 300 in a control method for the radiation imaging apparatus 100 according to the first exemplary embodiment. Specifically, FIG. 3 is the timing chart 300 illustrating operations of the radiation imaging apparatus 100 in the case of radiographic imaging which performs automatic exposure control (AEC) that is based on the irradiation dose of radiation R detected by the detection pixels 112. In FIG. 3, constituent elements similar to the constituent elements illustrated in FIG. 2 are assigned the respective same reference characters as those in FIG. 2, and the detailed description thereof is omitted here.

In the timing chart 300 illustrated in FIG. 3, the horizontal direction indicates elapsed time, and the vertical direction indicates the respective constituent elements. The respective constituent elements indicated in the vertical direction illustrated in FIG. 3 are, in order from the top, a drive line Vg1, a detection drive line Vg2/Vd1, a drive line Vg3, a drive line Vg4, a detection drive line Vg5/Vd2, a drive line Vg6, . . . , and a drive line Vgn. Subsequently, the respective constituent elements indicated in the vertical direction illustrated in FIG. 3 are a bias voltage Vs (pre-improvement) and a bias voltage Vs (post-improvement) for the bias line 114 and an output signal Sig (pre-improvement) and an output signal Sig (post-improvement) for the signal line 116 leading to a given amplification unit 141.

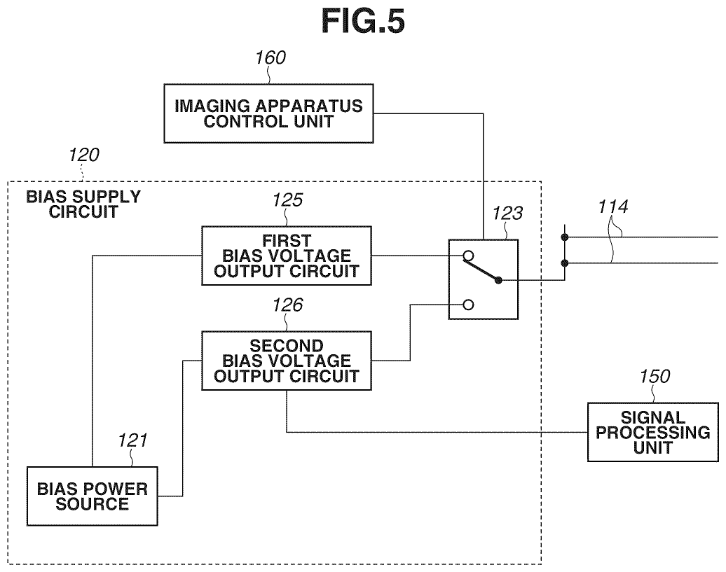

Referring to FIG. 3, drive signals are sequentially supplied to the drive lines Vg1 to Vgn. Here, since, before generation of a radiographic image for diagnosis, an image signal is read out by applying a drive signal to the detection drive line Vd, the output signal Sig (pre-improvement) obtained at that time becomes smaller and, moreover, the bias voltage Vs (pre-improvement) used at that time becomes less affected. Because of supplying the bias voltage Vs to the pixels, the bias line 114 is close to any signal line 116, and the variation in the bias voltage Vs exerts an influence upon the output signal Sig. For this reason, the output signal Sig obtained when the drive line Vg next to the detection drive line Vd is driven has a phase thereof delayed and a maximum value thereof changed as compared with the output signal Sig obtained when the drive signals Vg are consecutively driven, so that the image signal characteristic becomes different from that in another row and an artifact in a lateral stripe shape may occur. Thus, since, as indicated in the output signal Sig (pre-improvement), the difference in level of the output signal Sig becomes larger, this may become a factor for an artifact in a radiographic image. While, here, an example occurring when an image signal is read out by applying a drive signal to the detection drive line Vd has been described, the variation of the bias voltage Vs, which becomes a factor for an artifact, depends on the amount of electric charge accumulated in the detection pixel 112 connected to the detection drive line Vd to be scanned. Even in a case where, during irradiation of radiation R, the drive signal is not applied to the detection drive line Vd and no image signal is read out, i.e., automatic exposure control (AEC) is not performed, the above-mentioned artifact may occur. Specifically, even in this case, since the correction pixel 113 is also present in a pixel connected to the detection drive line Vd, the amount of electric charge different from the amount of electric charge accumulated in the imaging pixel 111 connected to the drive line Vg present near the detection drive line Vd is accumulated, so that an artifact may occur. In view of this, in the first exemplary embodiment, the internal configuration of the bias supply circuit 120 illustrated in FIG. 2 is configured as illustrated in FIG. 4 and FIG. 5.

FIG. 4 is a diagram illustrating a first example of an internal configuration of the bias supply circuit 120 illustrated in FIG. 2 in the radiation imaging apparatus 100 according to the first exemplary embodiment. In FIG. 4, constituent elements similar to the constituent elements illustrated in FIG. 2 are assigned the respective same reference characters as those in FIG. 2, and the detailed description thereof is omitted here.

As illustrated in FIG. 4, the bias supply circuit 120 includes a bias power source 121, an operational amplifier 122, a changeover switch 123, and a resistor 124.

The bias power source 121 is a power source which is used to supply a bias voltage Vs to the bias line 114.

The operational amplifier 122 amplifies a difference between an input voltage from the bias power source 121 and a bias voltage Vs which the bias supply circuit 120 is supplying to the bias line 114 (the bias voltage Vs varying as illustrated in FIG. 3) and then outputs the amplified difference to the signal processing unit 150 so as to use the difference for the above-mentioned radiographic imaging which performs automatic detection control. Moreover, in the bias supply circuit 120 illustrated in FIG. 4, the output of the operational amplifier 122 is fed back to the inverting input terminal thereof.

In the first exemplary embodiment, the imaging apparatus control unit 160 determines whether the imaging mode for radiographic imaging is radiographic imaging which performs automatic exposure control (AEC), based on the above-mentioned commands and parameters input from the control device 310 via the communication unit 170 and the communication control device 220. The imaging apparatus control unit 160, which performs such determination, configures a determination unit. Then, if the imaging apparatus control unit 160 has determined that the imaging mode for radiographic imaging is radiographic imaging which performs automatic exposure control (AEC), the imaging apparatus control unit 160 transmits, to the changeover switch 123, a changeover control signal for changing over to the side connecting to the resistor 124 (for example, a signal at high level). On the other hand, if the imaging apparatus control unit 160 has determined that the imaging mode for radiographic imaging is not radiographic imaging which performs automatic exposure control (AEC), the imaging apparatus control unit 160 transmits, to the changeover switch 123, a changeover control signal for changing over to the side not connecting to the resistor 124 (for example, a signal at low level). Specifically, in the first exemplary embodiment, examples of the radiographic imaging which does not perform automatic exposure control (AEC) include the above-mentioned radiographic imaging which performs automatic detection control. Thus, in the first exemplary embodiment, a configuration in which the imaging apparatus control unit 160 determines whether the imaging mode for radiographic imaging is radiographic imaging which performs automatic detection control (or is not radiographic imaging which performs automatic exposure control (AEC)), based on the above-mentioned commands and parameters input from the control device 310 can also be employed.

The changeover switch 123 changes over whether to connect to the resistor 124, depending on the changeover control signal received from the imaging apparatus control unit 160. When having received, from the imaging apparatus control unit 160, the changeover control signal for changing over to the side connecting to the resistor 124, the changeover switch 123 changes over switching to the side of a first resistance value 401, in which the resistor 124 is present. Thus, in a case where the imaging mode for radiographic imaging is radiographic imaging which performs automatic exposure control (AEC), the changeover switch 123 changes over switching to the side of the first resistance value 401, in which the resistor 124 is present. On the other hand, when having received, from the imaging apparatus control unit 160, the changeover control signal for changing over to the side not connecting to the resistor 124, the changeover switch 123 changes over switching to the side of a second resistance value 402, in which the resistor 124 is not present. Thus, in a case where the imaging mode for radiographic imaging is radiographic imaging which does not perform automatic exposure control (AEC) (in the first exemplary embodiment, the above-mentioned radiographic imaging which performs automatic detection control), the changeover switch 123 changes over switching to the side of the second resistance value 402, in which the resistor 124 is not present. Here, the first resistance value 401 is a resistance value present between the bias power source 121 and the bias line 114, and is, as merely an example, a resistance value in the range of 0.25 ohm (Ω) to 0.75 Ω. Moreover, the second resistance value 402 is a resistance value present between the bias power source 121 and the bias line 114, and is, as merely an example, a resistance value in the range of 0.0 ohm (Ω) to 0.1 Ω. Thus, the first resistance value 401 is larger than the second resistance value 402. Here, the explanation in terms of an output impedance of the bias supply circuit 120 is as follows. First, the output impedance of the bias supply circuit 120 in the case of radiographic imaging which performs automatic exposure control (AEC) (in the case of changing over the changeover switch 123 to the side of the first resistance vale 401) is referred to as a “first output impedance”. Moreover, the output impedance of the bias supply circuit 120 in the case of radiographic imaging which performs automatic detection control (in the case of changing over the changeover switch 123 to the side of the second resistance vale 402) is referred to as a “second output impedance”. In this case, the first output impedance is larger than the second output impedance.

As mentioned above, when having determined that the imaging mode for radiographic imaging is radiographic imaging which performs automatic exposure control (AEC), the imaging apparatus control unit 160 transmits, to the changeover switch 123, a changeover control signal for changing over to the side connecting to the resistor 124. Then, when having received, from the imaging apparatus control unit 160, the changeover control signal for changing over to the side connecting to the resistor 124, the changeover switch 123 changes over switching to the side of the first resistance value 401, in which the resistor 124 is present. In the first exemplary embodiment, in the case of radiographic imaging which performs automatic exposure control (AEC), setting the resistance value of the inside of the bias supply circuit 120 to the first resistance value 401, which is larger than the second resistance value 402, enables reducing an influence to be exerted on the bias voltage Vs when image signals have been read out from the respective pixels. With this setting, as indicated in the bias voltage Vs (post-improvement) illustrated in FIG. 3, the amplitude of variation of the bias voltage Vs becomes smaller as compared with that for the bias voltage Vs (pre-improvement), and, along with this change, as indicated in the output signal Sig (post-improvement) illustrated in FIG. 3, an influence to be exerted on the output signal Sig also becomes smaller as compared with that for the output signal Sig (pre-improvement). Thus, since, as indicated in the output signal Sig (post-improvement) illustrated in FIG. 3, the difference of level of the output signal Sig becomes smaller as compared with that for the output signal Sig (pre-improvement), it is possible to prevent or reduce an artifact which may occur in a radiographic image in the case of radiographic imaging which performs automatic exposure control (AEC). With regard to the explanation in terms of an output impedance of the bias supply circuit 120, the output impedance of the bias supply circuit 120 differs depending on whether the imaging mode for radiographic imaging is radiographic imaging which performs automatic exposure control (AEC). Specifically, in the first exemplary embodiment, in the case of radiographic imaging which performs automatic exposure control (AEC), the output impedance of the bias supply circuit 120 becomes larger than in the case of radiographic imaging which does not perform automatic exposure control (AEC) (in the first exemplary embodiment, in the case of radiographic imaging which performs automatic detection control). In terms of the output impedance of the bias supply circuit 120, it is also possible to prevent or reduce an artifact which may occur in a radiographic image in the case of radiographic imaging which performs automatic exposure control (AEC), thus enabling performing appropriate radiographic imaging.

On the other hand, in the case of the above-mentioned radiographic imaging which performs automatic detection control, which is different from radiographic imaging which performs automatic exposure control (AEC), if the resistance value of the inside of the bias supply circuit 120 is made larger, the current flowing through the bias supply circuit 120 becomes smaller, so that the sensitivity for detecting irradiation of radiation R may decrease. Such a decrease in detection sensitivity for irradiation of radiation R becomes a factor for causing false detection of irradiation of radiation R. Therefore, in the first exemplary embodiment, in the case of radiographic imaging which does not perform automatic exposure control (AEC) (in the case of radiographic imaging which performs automatic detection control), the resistance value of the inside of the bias supply circuit 120 is set to the second resistance value 402, which is smaller than the first resistance value 401. This enables increasing the detection sensitivity in irradiation of radiation R in the case of radiographic imaging which performs automatic detection control. With regard to the explanation in terms of an output impedance of the bias supply circuit 120, the output impedance of the bias supply circuit 120 differs depending on whether the imaging mode for radiographic imaging is radiographic imaging which performs automatic detection control. Specifically, in the first exemplary embodiment, in the case of radiographic imaging which performs automatic detection control, the output impedance of the bias supply circuit 120 becomes smaller than in the case of radiographic imaging which does not perform automatic detection control (in the first exemplary embodiment, in the case of radiographic imaging which performs automatic exposure control (AEC)). In terms of the output impedance of the bias supply circuit 120, it is also possible to prevent or reduce a decrease in detection sensitivity for irradiation of radiation R in the case of radiographic imaging which performs automatic detection control, thus enabling performing appropriate radiographic imaging. Furthermore, in the case of radiographic imaging which performs automatic detection control, to prevent or reduce an artifact which may occur in a radiographic image, it is also favorable to make the resistance value of the inside of the bias supply circuit 120 larger (make the output impedance of the bias supply circuit 120 larger) at the time of generation of a radiographic image. Therefore, in the case of radiographic imaging which performs automatic detection control, to increase the detection sensitivity for irradiation of radiation R, the resistance value of the inside of the bias supply circuit 120 is made smaller, but, during read-out of an image signal in progress, the resistance value can be changed to be made larger. With regard to the explanation in terms of the output impedance of the bias supply circuit 120, in the case of radiographic imaging which performs automatic detection control, the output impedance of the bias supply circuit 120 is made smaller, but, during read-out of an image signal in progress, the output impedance can be changed to be made larger. In this case, for example, even in the case of radiographic imaging which performs automatic detection control, during read-out of an image signal from the pixel array in progress, the imaging apparatus control unit 160 transmits, to the changeover switch 123, a changeover control signal for changing over to the side connecting to the resistor 124.

Furthermore, in consideration of an influence of the resistance value of the changeover switch 123 itself, it is favorable that the changeover switch 123 to be used is a field-effect transistor (FET) having low ON-resistance. Moreover, the resistor 124 can be implemented by a variable resistor.

In the above-described radiation imaging apparatus 100, the radiation detector 110 includes a pixel array, which includes a plurality of pixels 111 to 113 which acquires an electrical signal corresponding to incident radiation R and which includes a detection pixel 112 which detects the dose of radiation R as an electrical signal. Moreover, the bias line 114 lies between the bias power source 121 and the plurality of pixels 111 to 113, and is configured as a mass of wires which supply the bias voltage Vs from the bias power source 121 to the plurality of pixels 111 to 113. Then, in the case of radiographic imaging which performs automatic exposure control (AEC) that is based on the dose of radiation R detected by the detection pixel 112, the imaging apparatus control unit 160 controls the changeover switch 123 to provide the resistor 124 between the bias power source 121 and the bias line 114.

According to this configuration, in the case of radiographic imaging which performs automatic exposure control (AEC), it is possible to prevent or reduce an artifact which may occur in a radiographic image that is based on an electrical signal read out from the respective pixels, thus enabling performing appropriate radiographic imaging.

Moreover, in the case of radiographic imaging which does not perform automatic exposure control (AEC) (i.e., in the case of radiographic imaging which performs automatic detection control), the imaging apparatus control unit 160 controls the changeover switch 123 not to provide the resistor 124 between the bias power source 121 and the bias line 114.

According to this configuration, in the case of radiographic imaging which performs automatic detection control, it is possible to prevent or reduce a decrease in detection sensitivity in irradiation of radiation R (possible to keep the detection sensitivity at high level), thus enabling performing appropriate radiographic imaging.

While, in FIG. 4, a configuration in which different resistance values are changed over by the changeover switch 123 is illustrated, a configuration in which, instead of changeover of resistance values, for example, different bias voltage output values are changed over can also be applied to the aspect of the embodiments. FIG. 5 is a diagram illustrating a second example of an internal configuration of the bias supply circuit 120 illustrated in FIG. 2 in the radiation imaging apparatus according to the first exemplary embodiment. In FIG. 5, constituent elements similar to the constituent elements illustrated in FIG. 2 and FIG. 4 are assigned the respective same reference characters as those in FIG. 2 and FIG. 4, and the detailed description thereof is omitted here. As illustrated in FIG. 5, the bias supply circuit 120 includes a bias power source 121, a changeover switch 123, a first bias voltage output circuit 125, and a second bias voltage output circuit 126. A first bias voltage value which is output from the first bias voltage output circuit 125 and a second bias voltage value which is output from the second bias voltage output circuit 126 are respective different bias voltage values. Thus, the output impedance of the bias supply circuit 120 differs between the case where the changeover switch 123 performs switching to the side of the first bias voltage output circuit 125 and the case where the changeover switch 123 performs switching to the side of the second bias voltage output circuit 126. Examples of making different output impedance values in the bias supply circuit 120 include configurations of, for example, adding a capacitor, adjusting the capacity of a capacitor, using operational amplifiers having respective different properties, and adding an operational amplifier. In terms of the output impedance of the bias supply circuit 120, the case where the changeover switch 123 performs switching to the side of the first bias voltage output circuit 125 as illustrated in FIG. 5 corresponds to, for example, the case where the changeover switch 123 performs switching to the side of the first resistance value 401 as illustrated in FIG. 4. Similarly, in terms of the output impedance of the bias supply circuit 120, the case where the changeover switch 123 performs switching to the side of the second bias voltage output circuit 126 as illustrated in FIG. 5 corresponds to, for example, the case where the changeover switch 123 performs switching to the side of the second resistance value 402 as illustrated in FIG. 4. Here, the output impedance of the bias supply circuit 120 in the case of radiographic imaging which performs automatic exposure control (AEC) (in the case of changing over the changeover switch 123 to the side of the first bias voltage output circuit 125) is referred to as a “first output impedance”. Moreover, the output impedance of the bias supply circuit 120 in the case of radiographic imaging which performs automatic detection control (in the case of changing over the changeover switch 123 to the side of the second bias voltage output circuit 126) is referred to as a “second output impedance”. In this case, the first output impedance is larger than the second output impedance. In terms of the output impedance of the bias supply circuit 120, it is possible to prevent or reduce an artifact which may occur in a radiographic image in the case of radiographic imaging which performs automatic exposure control (AEC), thus enabling performing appropriate radiographic imaging. Moreover, in terms of the output impedance of the bias supply circuit 120, it is possible to prevent or reduce a decrease in detection sensitivity for irradiation of radiation R in the case of radiographic imaging which performs automatic detection control, thus enabling performing appropriate radiographic imaging.

Next, a second exemplary embodiment is described. Furthermore, in the following description of the second exemplary embodiment, particulars in common with those in the above-described first exemplary embodiment are omitted from description here, and only particulars different from those in the above-described first exemplary embodiment are described.

The outline configuration of a radiation imaging system according to the second exemplary embodiment is similar to the outline configuration of the radiation imaging system 10 according to the first exemplary embodiment illustrated in FIG. 1. Moreover, the outline configuration of a radiation imaging apparatus 100 according to the second exemplary embodiment is similar to the outline configuration of the radiation imaging apparatus 100 according to the first exemplary embodiment illustrated in FIG. 2.

In the above-described first exemplary embodiment, a configuration of changing over the resistance value of the inside of the bias supply circuit 120 based on the set imaging mode has been described. In the second exemplary embodiment, a configuration of changing over the resistance value of the inside of the bias supply circuit 120 based on whether there are synchronous communications between the radiation imaging apparatus 100 and the radiation generation device 230 is described. In the second exemplary embodiment, it is assumed that, in the case of radiographic imaging which performs automatic exposure control (AEC), there are synchronous communications between the radiation imaging apparatus 100 and the radiation generation device 230. On the other hand, in the second exemplary embodiment, it is assumed that, in the case of radiographic imaging which does not perform automatic exposure control (AEC) and performs automatic detection control, there are no synchronous communications between the radiation imaging apparatus 100 and the radiation generation device 230.

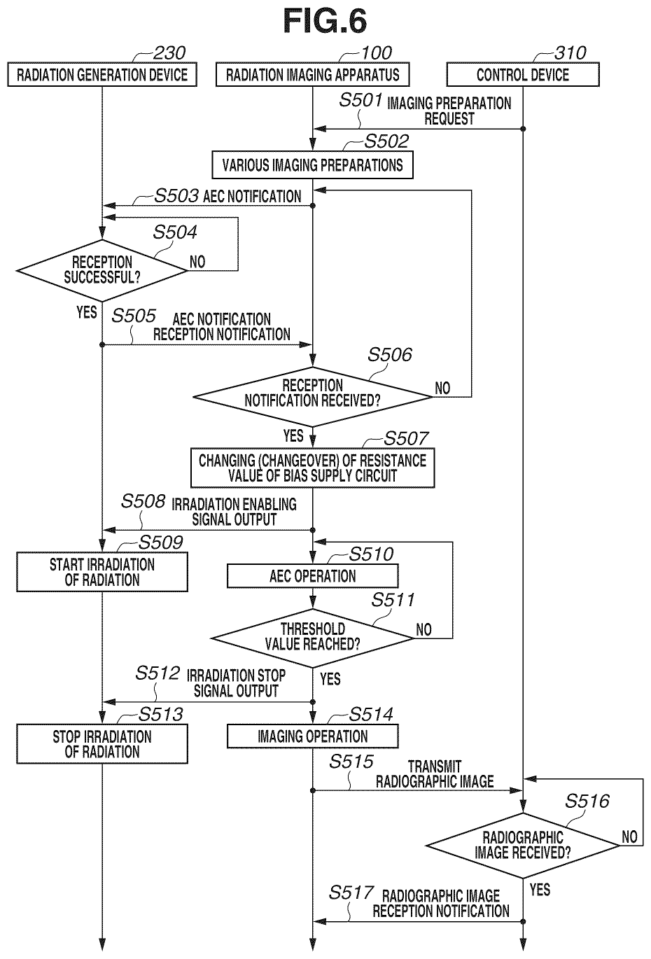

FIG. 6 is a diagram illustrating an example of a flowchart in a control method for the radiation imaging system 10 according to the second exemplary embodiment. Specifically, FIG. 6 illustrates examples of respective processing operations which are internally performed by the radiation imaging apparatus 100, the radiation generation device 230, and the control device 310 illustrated in FIG. 1 and communication processing operations which are performed between the radiation imaging apparatus 100, the radiation generation device 230, and the control device 310, in the case of radiographic imaging which performs automatic exposure control (AEC).

First, in step S501 illustrated in FIG. 6, the communication unit 170 of the radiation imaging apparatus 100 receives a command for imaging preparation request from the control device 310.

Next, in step S502, the imaging apparatus control unit 160 of the radiation imaging apparatus 100 performs various imaging preparatory operations. In this instance, the various imaging preparatory operations include acquisition processing for correction data for correction which removes an offset noise component at the time of radiographic imaging which performs automatic exposure control (AEC) and processing for resetting the respective pixels by sequentially sending drive signals to the drive lines 115.

Next, in step S503, the communication unit 170 of the radiation imaging apparatus 100 transmits, to the radiation generation device 230, a notification signal concerning automatic exposure control (AEC) to check whether synchronous communications are available.

Next, in step S504, the radiation generation device 230 determines whether the notification signal concerning automatic exposure control (AEC) has been received from the radiation imaging apparatus 100. If it is determined that the notification signal concerning automatic exposure control (AEC) has not been received from the radiation imaging apparatus 100 (NO in step S504), the radiation generation device 230 waits in step S504 until the notification signal concerning automatic exposure control (AEC) has been received from the radiation imaging apparatus 100.

On the other hand, if, in step S504, it is determined that the notification signal concerning automatic exposure control (AEC) has been received from the radiation imaging apparatus 100 (YES in step S504), the radiation generation device 230 advances the processing to step S505.

In step S505, the radiation generation device 230 transmits, to the radiation imaging apparatus 100, a notification signal indicating that the notification signal concerning automatic exposure control (AEC) has been received.

Next, in step S506, the radiation imaging apparatus 100 determines whether the notification signal concerning automatic exposure control (AEC) has been received from the radiation generation device 230. If it is determined that the notification signal concerning automatic exposure control (AEC) has not been received from the radiation generation device 230 (NO in step S506), the radiation imaging apparatus 100 returns the processing to step S503, and then, the radiation imaging apparatus 100 and the radiation generation device 230 perform processing operations in step S503 and subsequent steps again.

On the other hand, if, in step S506, it is determined that the notification signal concerning automatic exposure control (AEC) has been received from the radiation generation device 230 (YES in step S506), the radiation imaging apparatus 100 advances the processing to step S507.

In step S507, the imaging apparatus control unit 160 of the radiation imaging apparatus 100 transmits, to the changeover switch 123, a changeover control signal for changing over to the side connecting to the resistor 124 illustrated in FIG. 4, in preparation for radiographic imaging which performs automatic exposure control (AEC). Then, when having received, from the imaging apparatus control unit 160, the changeover control signal for changing over to the side connecting to the resistor 124, the changeover switch 123 changes over switching to the side of the first resistance value 401, in which the resistor 124 illustrated in FIG. 4 is present.

Next, in step S508, the communication unit 170 of the radiation imaging apparatus 100 outputs (transmits) an irradiation enabling signal for radiation R to the radiation generation device 230.

Then, upon receiving the irradiation enabling signal for radiation R from the radiation imaging apparatus 100, next, in step S509, the radiation generation device 230 causes the radiation source 240 to start irradiating radiation R toward the subject H and the radiation imaging apparatus 100.

Moreover, after the radiation imaging apparatus 100 transmits the irradiation enabling signal for radiation R to the radiation generation device 230, next, in step S510, the imaging apparatus control unit 160 starts an automatic exposure control (AEC) operation.

Next, in step S511, the imaging apparatus control unit 160 of the radiation imaging apparatus 100 determines whether the irradiation dose of radiation R detected by the detection pixels 112 of the radiation detector 110 has reached a threshold value. If it is determined that the irradiation dose of radiation R detected by the detection pixels 112 of the radiation detector 110 has not reached the threshold value (NO in step S511), the radiation imaging apparatus 100 returns the processing to step S510, and then, the radiation imaging apparatus 100 performs processing operations in step S510 and the subsequent step again.

On the other hand, if, in step S511, it is determined that the irradiation dose of radiation R detected by the detection pixels 112 of the radiation detector 110 has reached the threshold value (YES in step S511), the radiation imaging apparatus 100 advances the processing to step S512.

In step S512, the communication unit 170 of the radiation imaging apparatus 100 outputs (transmits) an irradiation stop signal for radiation R to the radiation generation device 230.

Then, upon receiving the irradiation stop signal for radiation R from the radiation imaging apparatus 100, next, in step S513, the radiation generation device 230 causes the radiation source 240 to stop irradiating radiation R.

Moreover, after the radiation imaging apparatus 100 transmits the irradiation stop signal for radiation R to the radiation generation device 230, next, in step S514, the imaging apparatus control unit 160 performs an imaging operation for the subject H by the imaging pixels 111 of the radiation detector 110.

Next, in step S515, the communication unit 170 of the radiation imaging apparatus 100 transmits, to the control device 310, a radiographic image of the subject H obtained by the imaging operation in step S514.

Next, in step S516, the control device 310 determines whether the radiographic image of the subject H obtained by the imaging operation in step S514 has been received from the radiation imaging apparatus 100. If it is determined that the radiographic image of the subject H obtained by the imaging operation in step S514 has not been received from the radiation imaging apparatus 100 (NO in step S516), the control device 310 waits in step S516 until the radiographic image of the subject H is received.

On the other hand, if, in step S516, it is determined that the radiographic image of the subject H obtained by the imaging operation in step S514 has been received from the radiation imaging apparatus 100 (YES in step S516), the control device 310 advances the processing to step S517.

In step S517, the control device 310 transmits, to the radiation imaging apparatus 100, a notification signal indicating that the radiographic image of the subject H has been received. Then, upon the completion of a processing operation in step S517, the radiation imaging apparatus 100 ends the processing illustrated in the flowchart of FIG. 6.

In the second exemplary embodiment, in a case where there are synchronous communications between the radiation imaging apparatus 100 and the radiation generation device 230, the imaging apparatus control unit 160 determines that the imaging mode for radiographic imaging is radiographic imaging which performs automatic exposure control (AEC). Moreover, in a case where there are no synchronous communications between the radiation imaging apparatus 100 and the radiation generation device 230, the imaging apparatus control unit 160 determines that the imaging mode for radiographic imaging is not radiographic imaging which performs automatic exposure control (AEC). For example, the imaging apparatus control unit 160 can determine whether the imaging mode for radiographic imaging is radiographic imaging which performs automatic exposure control (AEC), by detecting insertion or extraction of a synchronous communication cable used for performing synchronous communications as the communication cable 201 into or from the wired communication unit 103 of the radiation imaging apparatus 100. Furthermore, in the second exemplary embodiment, synchronous communications are communications for at least one of an irradiation enabling signal for radiation R, an irradiation start signal for radiation R, and an irradiation stop signal for radiation R. Furthermore, in the second exemplary embodiment, the synchronous communications are not limited to communications for these signals, and the synchronous communications can be checked by, for example, checking of a response to a ping command.

In the second exemplary embodiment, in a case where there are synchronous communications between the radiation imaging apparatus 100 and the radiation generation device 230, the imaging apparatus control unit 160 determines that the imaging mode for radiographic imaging is radiographic imaging which performs automatic exposure control (AEC). Then, in a case where there are synchronous communications between the radiation imaging apparatus 100 and the radiation generation device 230, the imaging apparatus control unit 160 controls the changeover switch 123 to change over switching to the side of the first resistance value 401, in which the resistor 124 illustrated in FIG. 4 is present. On the other hand, in a case where there are no synchronous communications between the radiation imaging apparatus 100 and the radiation generation device 230, the imaging apparatus control unit 160 determines that the imaging mode for radiographic imaging is not radiographic imaging which performs automatic exposure control (AEC) but, for example, radiographic imaging which performs automatic detection control. Then, in a case where there are no synchronous communications between the radiation imaging apparatus 100 and the radiation generation device 230, the imaging apparatus control unit 160 controls the changeover switch 123 to change over switching to the side of the second resistance value 402, in which the resistor 124 illustrated in FIG. 4 is not present.

In this way, the second exemplary embodiment is configured to determine whether to provide the resistor 124 between the bias power source 121 and the bias line 114, based on whether there are synchronous communications between the radiation imaging apparatus 100 and the radiation generation device 230.

According to this configuration, as with the above-described first exemplary embodiment, in the case of radiographic imaging which performs automatic exposure control (AEC), it is possible to prevent or reduce an artifact which may occur in a radiographic image that is based on an electrical signal read out from the respective pixels, thus enabling performing appropriate radiographic imaging. Additionally, in the case of radiographic imaging which performs automatic detection control, it is possible to prevent or reduce a decrease in detection sensitivity in irradiation of radiation R (possible to keep the detection sensitivity at high level), thus enabling performing appropriate radiographic imaging. Furthermore, while, in the second exemplary embodiment, an example using the bias supply circuit 120 illustrated in FIG. 4 has been described, a configuration using the bias supply circuit 120 illustrated in FIG. 5 can be applied to the second exemplary embodiment. When this configuration is employed, the case of changing over the changeover switch 123 to the side of the first resistance value 401, in which the resistor 124 illustrated in FIG. 4 is present, corresponds to the case of changing over the changeover switch 123 to the side of the first bias voltage output circuit 125 illustrated in FIG. 5. Moreover, the case of changing over the changeover switch 123 to the side of the second resistance value 402, in which the resistor 124 illustrated in FIG. 4 is not present, corresponds to the case of changing over the changeover switch 123 to the side of the second bias voltage output circuit 126 illustrated in FIG. 5.

Furthermore, in the second exemplary embodiment, the processing operation which the radiation imaging apparatus 100 performs after receiving the imaging preparation request in step S501 and the processing operation which the radiation imaging apparatus 100 performs after receiving the AEC communication receiving notification in step S505 are not limited to the processing operations illustrated in FIG. 6, but can be changed as appropriate. Moreover, in a case where a configuration of the radiation imaging system 10 in which a relay unit is connected to between the radiation imaging apparatus 100 and the radiation generation device 230 is employed, whether the above-mentioned synchronous communications are present can be determined by checking of synchronous communications between the radiation imaging apparatus 100 and the relay unit. In this instance, since the relay unit may be incompatible with radiographic imaging which performs automatic exposure control (AEC), it is favorable to simultaneously perform checking as to whether the relay unit is compatible with radiographic imaging which performs automatic exposure control (AEC).

Furthermore, each of the above-described exemplary embodiments of the disclosure is merely an example of concretization in implementing the disclosure, and the technical scope of the disclosure should not be construed to be limited to such exemplary embodiments. Thus, the aspect of the embodiments can be implemented in various ways without departing from the technical idea or principal characteristics thereof.

The disclosure of the above-described exemplary embodiments includes the following configurations, methods, and storage media.

### <Configuration 1>

A radiation imaging apparatus including:

a pixel array including a plurality of pixels configured to acquire an electrical signal corresponding to incident radiation, the plurality of pixels including a detection pixel configured to detect a dose of the radiation as the electrical signal; and

a bias supply circuit configured to supply a bias voltage to the plurality of pixels,

wherein an output impedance of the bias supply circuit differs depending on whether an imaging mode for radiographic imaging is radiographic imaging which performs automatic exposure control that is based on the dose of the radiation detected by the detection pixel.

### <Configuration 2>

A radiation imaging apparatus including:

a pixel array including a plurality of pixels configured to acquire an electrical signal corresponding to incident radiation, the plurality of pixels including a detection pixel configured to detect a dose of the radiation as the electrical signal; and

a bias supply circuit configured to supply a bias voltage to the plurality of pixels,

wherein an output impedance of the bias supply circuit differs depending on whether an imaging mode for radiographic imaging is radiographic imaging which performs automatic detection control which automatically detects irradiation of the radiation to the pixel array.

### <Configuration 3>

The radiation imaging apparatus as set forth in Configuration 2, wherein the output impedance of the bias supply circuit differs depending on whether the imaging mode for radiographic imaging is radiographic imaging which performs the automatic detection control and reading-out of the electrical signal from the pixels is in progress.

### <Configuration 4>

The radiation imaging apparatus as set forth in Configuration 2 or 3, further including a changeover unit configured to change over the output impedance of the bias supply circuit depending on whether the imaging mode for radiographic imaging is radiographic imaging which performs the automatic detection control and reading-out of the electrical signal from the pixels is in progress.

### <Configuration 5>

The radiation imaging apparatus as set forth in Configuration 1, wherein, when the output impedance of the bias supply circuit in a case where the imaging mode for radiographic imaging is radiographic imaging which performs the automatic exposure control is referred to as a first output impedance and the output impedance of the bias supply circuit in a case where the imaging mode for radiographic imaging is radiographic imaging which performs automatic detection control which automatically detects irradiation of the radiation to the pixel array is referred to as a second output impedance, the first output impedance is larger than the second output impedance.

### <Configuration 6>

The radiation imaging apparatus as set forth in Configuration 1, further including a changeover unit configured to change over the output impedance of the bias supply circuit depending on whether the imaging mode for radiographic imaging is radiographic imaging which performs the automatic exposure control or radiographic imaging which performs automatic detection control which automatically detects irradiation of the radiation to the pixel array.

### <Configuration 7>

The radiation imaging apparatus as set forth in Configuration 6, further including a determination unit configured to perform determination as to whether the imaging mode for radiographic imaging is radiographic imaging which performs the automatic exposure control or radiographic imaging which performs the automatic detection control,

wherein the changeover unit changes over the output impedance of the bias supply circuit based on a result of the determination performed by the determination unit.

### <Configuration 8>

The radiation imaging apparatus as set forth in Configuration 7, wherein the determination unit performs determination as to whether the imaging mode for radiographic imaging is radiographic imaging which performs the automatic exposure control or radiographic imaging which performs the automatic detection control, based on a command or parameter input from a control device connected to the radiation imaging apparatus in such a way as to be able to communicate with the radiation imaging apparatus.

### <Configuration 9>

The radiation imaging apparatus as set forth in Configuration 8, wherein the command is a command indicating ON/OFF of a function of the automatic exposure control or a command indicating the imaging mode for radiographic imaging.

### <Configuration 10>

The radiation imaging apparatus as set forth in Configuration 9, wherein the command indicating the OFF of the function of the automatic exposure control is a command indicating ON of a function of the automatic detection control.

### <Configuration 11>

The radiation imaging apparatus as set forth in any one of Configurations 8 to 10, wherein the parameter includes at least one of a selected region in a region of interest of the pixel array for use in a function of the automatic exposure control, a threshold value for a dose of the radiation, an arithmetic operation method in using a plurality of regions of interest each corresponding to the region of interest, a sensitivity correction value, a density correction value, and a sensor rotational angle.

### <Configuration 12>

The radiation imaging apparatus as set forth in any one of Configurations 8 to 10, wherein the parameter includes at least one of a detection sensitivity and a detection threshold value of a function of the automatic detection control.

### <Configuration 13>

The radiation imaging apparatus as set forth in any one of Configurations 7 to 10,

wherein, in a case where there are synchronous communications between the radiation imaging apparatus and a radiation generation device which causes the radiation to be generated, the determination unit determines that the imaging mode for radiographic imaging is radiographic imaging which performs the automatic exposure control, and

wherein, in a case where there are no synchronous communications between the radiation imaging apparatus and the radiation generation device, the determination unit determines that the imaging mode for radiographic imaging is radiographic imaging which performs the automatic detection control.

### <Configuration 14>

The radiation imaging apparatus as set forth in Configuration 13, wherein the synchronous communications are communications for at least one of an irradiation enabling signal for the radiation, an irradiation start signal for the radiation, and an irradiation stop signal for the radiation.

### <Configuration 15>

The radiation imaging apparatus as set forth in Configuration 13 or 14, wherein the determination unit determines whether the imaging mode for radiographic imaging is radiographic imaging which performs the automatic exposure control or radiographic imaging which performs the automatic detection control, by detecting insertion or extraction of a synchronous communication cable used for performing the synchronous communications into or from the radiation imaging apparatus.

### <Method 1>

A control method for a radiation imaging apparatus including a pixel array including a plurality of pixels configured to acquire an electrical signal corresponding to incident radiation, the plurality of pixels including a detection pixel configured to detect a dose of the radiation as the electrical signal, and a bias supply circuit configured to supply a bias voltage to the plurality of pixels, the control method including:

performing control to cause an output impedance of the bias supply circuit to differ depending on whether an imaging mode for radiographic imaging is radiographic imaging which performs automatic exposure control that is based on the dose of the radiation detected by the detection pixel.

### <Method 2>

A control method for a radiation imaging apparatus including a pixel array including a plurality of pixels configured to acquire an electrical signal corresponding to incident radiation, the plurality of pixels including a detection pixel configured to detect a dose of the radiation as the electrical signal, and a bias supply circuit configured to supply a bias voltage to the plurality of pixels, the control method including:

performing control to cause an output impedance of the bias supply circuit to differ depending on whether an imaging mode for radiographic imaging is radiographic imaging which performs automatic detection control which automatically detects irradiation of the radiation to the pixel array.

### <Storage Medium 1>

A non-transitory computer-readable storage medium storing computer-executable instructions that, when executed by a computer, cause the computer to perform a control method for a radiation imaging apparatus including a pixel array including a plurality of pixels configured to acquire an electrical signal corresponding to incident radiation, the plurality of pixels including a detection pixel configured to detect a dose of the radiation as the electrical signal, and a bias supply circuit configured to supply a bias voltage to the plurality of pixels, the control method including:

performing control to cause an output impedance of the bias supply circuit to differ depending on whether an imaging mode for radiographic imaging is radiographic imaging which performs automatic exposure control that is based on the dose of the radiation detected by the detection pixel.

### <Storage Medium 2>

A non-transitory computer-readable storage medium storing computer-executable instructions that, when executed by a computer, cause the computer to perform a control method for a radiation imaging apparatus including a pixel array including a plurality of pixels configured to acquire an electrical signal corresponding to incident radiation, the plurality of pixels including a detection pixel configured to detect a dose of the radiation as the electrical signal, and a bias supply circuit configured to supply a bias voltage to the plurality of pixels, the control method including:

performing control to cause an output impedance of the bias supply circuit to differ depending on whether an imaging mode for radiographic imaging is radiographic imaging which performs automatic detection control which automatically detects irradiation of the radiation to the pixel array.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-062288 filed Apr. 8, 2024, and Japanese Patent Application No. 2025-011405 filed Jan. 27, 2025, which are hereby incorporated by reference herein in their entirety.

What is claimed is:

1. An apparatus comprising:
a pixel array including a plurality of pixels configured to acquire a signal corresponding to incident radiation, the plurality of pixels including a detection pixel configured to detect a dose of the radiation as the signal; and
a bias supply circuit configured to supply a bias voltage to the plurality of pixels,
wherein an output impedance of the bias supply circuit differs depending on whether an imaging mode for radiographic imaging is radiographic imaging which performs automatic exposure control that is based on the dose of the radiation detected by the detection pixel.

2. An apparatus comprising:
a pixel array including a plurality of pixels configured to acquire a signal corresponding to incident radiation, the plurality of pixels including a detection pixel configured to detect a dose of the radiation as the signal; and
a bias supply circuit configured to supply a bias voltage to the plurality of pixels,
wherein an output impedance of the bias supply circuit differs depending on whether an imaging mode for radiographic imaging is radiographic imaging which performs automatic detection control which automatically detects irradiation of the radiation to the pixel array.

3. The apparatus according to claim 2, wherein the output impedance of the bias supply circuit differs depending on whether the imaging mode for radiographic imaging is radiographic imaging which performs the automatic detection control and reading-out of the signal from the pixels is in progress.

4. The apparatus according to claim 2, further comprising a changeover unit configured to change over the output impedance of the bias supply circuit depending on whether the imaging mode for radiographic imaging is radiographic imaging which performs the automatic detection control and reading-out of the signal from the pixels is in progress.

5. The apparatus according to claim 1, wherein, when the output impedance of the bias supply circuit in a case where the imaging mode for radiographic imaging is radiographic imaging which performs the automatic exposure control is referred to as a first output impedance and the output impedance of the bias supply circuit in a case where the imaging mode for radiographic imaging is radiographic imaging which performs automatic detection control which automatically detects irradiation of the radiation to the pixel array is referred to as a second output impedance, the first output impedance is larger than the second output impedance.

6. The apparatus according to claim 1, further comprising a changeover unit configured to change over the output impedance of the bias supply circuit depending on whether the imaging mode for radiographic imaging is radiographic imaging which performs the automatic exposure control or radiographic imaging which performs automatic detection control which automatically detects irradiation of the radiation to the pixel array.

7. The apparatus according to claim 6, further comprising a determination unit configured to perform determination as to whether the imaging mode for radiographic imaging is radiographic imaging which performs the automatic exposure control or radiographic imaging which performs the automatic detection control,
wherein the changeover unit changes over the output impedance of the bias supply circuit based on a result of the determination performed by the determination unit.

8. The apparatus according to claim 7, wherein the determination unit performs determination as to whether the imaging mode for radiographic imaging is radiographic imaging which performs the automatic exposure control or radiographic imaging which performs the automatic detection control, based on a command or parameter input from a control device connected to the apparatus in such a way as to be able to communicate with the apparatus.

9. The apparatus according to claim 8, wherein the command is a command indicating ON/OFF of a function of the automatic exposure control or a command indicating the imaging mode for radiographic imaging.

10. The apparatus according to claim 9, wherein the command indicating the OFF of the function of the automatic exposure control is a command indicating ON of a function of the automatic detection control.

11. The apparatus according to claim 8, wherein the parameter includes at least one of a selected region in a region of interest of the pixel array for use in a function of the automatic exposure control, a threshold value for a dose of the radiation, an arithmetic operation method in using a plurality of regions of interest each corresponding to the region of interest, a sensitivity correction value, a density correction value, and a sensor rotational angle.

12. The apparatus according to claim 8, wherein the parameter includes at least one of a detection sensitivity and a detection threshold value of a function of the automatic detection control.

13. The apparatus according to claim 7,
wherein, in a case where there are synchronous communications between the apparatus and a radiation generation device which causes the radiation to be generated, the determination unit determines that the imaging mode for radiographic imaging is radiographic imaging which performs the automatic exposure control, and
wherein, in a case where there are no synchronous communications between the apparatus and the radiation generation device, the determination unit determines that the imaging mode for radiographic imaging is radiographic imaging which performs the automatic detection control.

14. The apparatus according to claim 13, wherein the synchronous communications are communications for at least one of an irradiation enabling signal for the radiation, an irradiation start signal for the radiation, and an irradiation stop signal for the radiation.

15. The apparatus according to claim 13, wherein the determination unit determines whether the imaging mode for radiographic imaging is radiographic imaging which performs the automatic exposure control or radiographic imaging which performs the automatic detection control, by detecting insertion or extraction of a synchronous communication cable used for performing the synchronous communications into or from the apparatus.

16. A method for an apparatus including a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, the method comprising:
performing control to cause an output impedance of the bias supply circuit to differ depending on whether an imaging mode for radiographic imaging is radiographic imaging which performs automatic exposure control that is based on the dose of the radiation detected by the detection pixel.

17. A method for an apparatus including a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, the method comprising:
performing control to cause an output impedance of the bias supply circuit to differ depending on whether an imaging mode for radiographic imaging is radiographic imaging which performs automatic detection control which automatically detects irradiation of the radiation to the pixel array.

18. A non-transitory computer-readable storage medium storing computer-executable instructions that, when executed by a computer, cause the computer to perform a method for an apparatus including a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, the method comprising:
performing control to cause an output impedance of the bias supply circuit to differ depending on whether an imaging mode for radiographic imaging is radiographic imaging which performs automatic exposure control that is based on the dose of the radiation detected by the detection pixel.

19. A non-transitory computer-readable storage medium storing computer-executable instructions that, when executed by a computer, cause the computer to perform a control method for an apparatus including a pixel array including a plurality of pixels configured to acquire a signal corresponding to incident radiation, the plurality of pixels including a detection pixel configured to detect a dose of the radiation as the signal, and a bias supply circuit configured to supply a bias voltage to the plurality of pixels, the control method comprising:
performing control to cause an output impedance of the bias supply circuit to differ depending on whether an imaging mode for radiographic imaging is radiographic imaging which performs automatic detection control which automatically detects irradiation of the radiation to the pixel array.
